(19) United States
(12) Patent Application Publication
(10) Pub. No.: US 2012/0154586 A1
(43) Pub. Date: Jun. 21, 2012

(54) CALIBRATION CIRCUIT FOR AUTOMATICALLY CALIBRATING A VIEW IMAGE AROUND A CAR AND METHOD THEREOF

(76) Inventors: Cheng-Sheng Chung, Hsinchu (TW); Shu-Peng Hsu, Hsinchu (TW)

(21) Appl. No.: 13/163,759

(22) Filed: Jun. 20, 2011

Related U.S. Application Data
(60) Provisional application No. 61/423,598, filed on Dec. 16, 2010.

(51) Int. Cl. H04N 7/18

(52) U.S. Cl. 348/148

(57) ABSTRACT

A method of automatically calibrating a view image around a car includes installing at least one camera at front side, rear side, left side, and right side of the car respectively, obtaining a size of the car and location information of the at least four cameras, setting a plurality of reference points corresponding to each camera of the at least four cameras, utilizing one camera of the at least four cameras to capture a fisheye image including the plurality of reference points corresponding to the one camera, executing fisheye correction on the fisheye image to generate a corrected fisheye image, determining whether an image center of the camera is located within a predetermined range according to the corrected fisheye image, and performing a corresponding operation according to a determination result.

### CROSS REFERENCE TO RELATED APPLICATIONS

This application claims the benefit of U.S. Provisional Application No. 61/423,598, filed on Dec. 16, 2010 and entitled “In the proposed approach, the images, which are captured by the cameras installed around the car, are quickly calibrated by using algorithms based on the installed reference points around the car, and then they are stitched automatically and are shown in the in-car display device,” the contents of which are incorporated herein by reference.

### BACKGROUND OF THE INVENTION

1. Field of the Invention

The present invention is related to a calibration circuit for automatically calibrating a view image around a car and method thereof, and particularly to a calibration circuit and method thereof that execute operations on images including a plurality of reference points set at front side, rear side, left side, and right side of the car to automatically correct the images rapidly, automatically stitch the corrected images to generate a view image around the car, and output the view image around the car to a monitor of the car.

2. Description of the Prior Art

Automobile safety is increasingly important to drivers, so car manufacturers have developed technology that provides a real time view image around a car to satisfy the driver's desire for safety.

Because cars come in different shapes and sizes, installation angle and location of each camera varies with shape and size of each type of car. In addition, when a camera is installed on a car, a view angle and an image center of the camera also vary with shape and size of the car. Further, each camera has a different lens curvature parameter. To sum up, the car manufacturers can not automatically calibrate a view image around a car rapidly due to the above mentioned factors, so the car manufacturers can not rapidly mass produce cars providing the real time view image around the car.

### SUMMARY OF THE INVENTION

An embodiment provides a method of automatically calibrating a view image around a car. The method includes installing at least one camera at front side, rear side, left side, and right side of the car, respectively; obtaining a size of the car and location information of the at least four cameras; setting a plurality of reference points corresponding to each camera of the at least four cameras according to the size of the car and the location information of the at least four cameras; utilizing one camera of the at least four cameras to capture a fisheye image including the plurality of reference points corresponding to the one camera; executing fisheye correction on the fisheye image to generate a corrected fisheye image; determining whether an image center of the one camera is located within a predetermined range according to the corrected fisheye image; performing a corresponding operation according to a determination result.

Another embodiment provides a calibration circuit for automatically calibrating a view image around a car. The calibration circuit includes a view angle adjustment unit, a fisheye image calibration unit, a scaling engine, a reference point detection unit, and an image stitch unit. The view angle adjustment unit is used for receiving fisheye images captured by at least one camera installed at front side, rear side, left side, and right side of a car, respectively, and adjusting the fisheye images captured by the at least four cameras according to a view angle adjustment parameter corresponding to each camera of the at least four cameras. The fisheye image calibration unit is used for executing fisheye correction on a fisheye image captured by each camera of the at least four cameras to generate a corrected fisheye image, wherein the fisheye image includes a plurality of reference points corresponding to the camera. The scaling engine is coupled to the fisheye image calibration unit for scaling the corrected fisheye image. The reference point detection unit is coupled to the scaling engine for detecting a plurality of reference points included by the scaled corrected fisheye image, and transmitting the plurality of reference points included by the scaled corrected fisheye image to an external processor through a bus. The image stitch unit is coupled to the reference point detection unit for generating a view image corresponding to the front side of the car according to the corrected fisheye image of at least one camera corresponding to the front side of the car and a first image projection equation, generating a view image corresponding to the rear side of the car according to the corrected fisheye image of at least one camera corresponding to the rear side of the car and a second image projection equation, generating a view image corresponding to the left side of the car according to the corrected fisheye image of at least one camera corresponding to the left side of the car and a third image projection equation, generating a view image corresponding to the right side of the car according to the corrected fisheye image of at least one camera corresponding to the right side of the car and a fourth image projection equation, and stitching the view image corresponding to the front side of the car, the view image corresponding to the rear side of the car, the view image corresponding to the left side of the car, and the view image corresponding to the right side of the car to generate the view image around the car and outputting the view image around the car to a car monitor.

The present invention provides a calibration circuit for automatically calibrating a view image around a car and method thereof. The calibration circuit and method thereof set a plurality of reference points corresponding to each camera of cameras installed at front side, rear side, left side, and right side of the car, respectively, according to size of the car and location information of the cameras. Then, the calibration circuit and method thereof utilize each camera of the cameras to capture a fisheye image including the plurality of reference points corresponding to each camera of the cameras, and generate a corresponding corrected fisheye image according to the fisheye image corresponding to each camera of the cameras. Therefore, the present invention can rapidly correct an image center, a lens curvature parameter, and a view angle adjustment parameter of each camera according to the corrected fisheye image corresponding to each camera. Thus, the present invention can mass produce cars that provide a real time view image around a car rapidly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A, FIG. 1B, and FIG. 1C is a diagram illustrating a size of a car and location information of cameras installed at front side, rear side, left side, and right side of the car, respectively.

FIG. 1D is a diagram illustrating setting a plurality of reference points corresponding to each camera of the cameras according to the size of the car and the location information of the cameras.

FIG. 2 is a diagram illustrating a calibration circuit for automatically calibrating a view image around a car according to an embodiment.

FIG. 3A is a diagram illustrating the camera capturing the fisheye image including the reference points corresponding to the camera.

FIG. 3B is a diagram illustrating the fisheye image calibration unit executing fisheye correction on the fisheye image to generate a corrected fisheye image.

FIG. 3C is a diagram illustrating the external processor determining search regions of reference points in the corrected fisheye image.

FIG. 3D is a diagram illustrating the external processor executing image binarization on the search region of the reference point.

FIG. 4A is a diagram illustrating a fisheye image captured by the camera when a view angle of the camera is located outside predetermined view angle range.

FIG. 4B is a diagram illustrating the view angle adjustment unit generating a fisheye image by a view angle adjustment parameter corresponding to the camera.

FIG. 5A and FIG. 5B are diagrams illustrating after the fisheye image calibration unit executing the fisheye correction on a fisheye image captured by the camera to generate a non-ideal corrected fisheye images.

FIG. 6A is a diagram illustrating a fisheye image captured by the camera with a shifted image center.

FIG. 6B is a diagram illustrating after the fisheye image calibration unit executing the fisheye correction on the fisheye image to generate a corrected fisheye image.

FIG. 7A and FIG. 7B are diagrams illustrating the image stitch unit generating a view image corresponding to the front side of car according to a corrected fisheye image corresponding to the camera and a first image projection equation.

FIG. 8 is a diagram illustrating the image stitch unit generates a view image around the car according to the view images.

FIG. 9 is a flowchart illustrating a method of automatically calibrating a view image around a car according to another embodiment.

FIG. 10A and FIG. 10B are flowcharts illustrating a method of automatically calibrating a view image around a car according to another embodiment.

FIG. 11A and FIG. 11B are flowcharts illustrating a method of automatically calibrating a view image around a car according to another embodiment.

FIG. 12A and FIG. 12B are flowcharts illustrating a method of automatically calibrating a view image around a car according to another embodiment.

### DETAILED DESCRIPTION

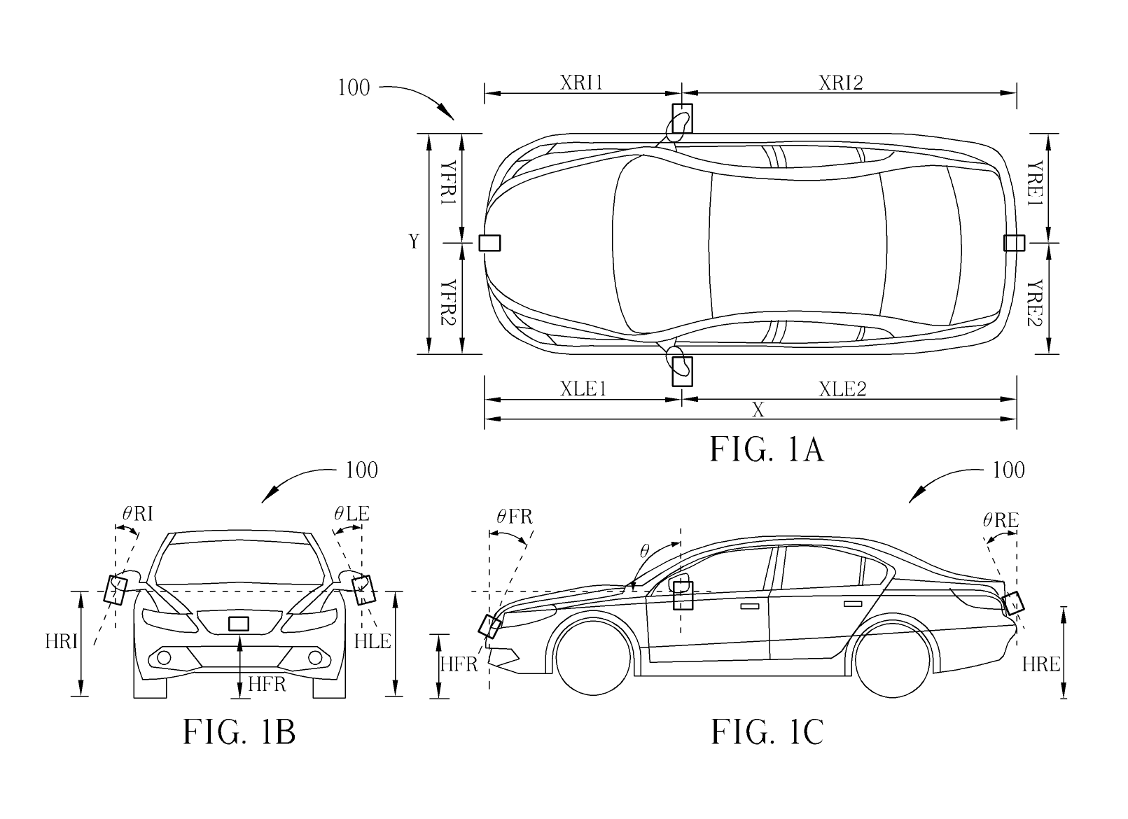

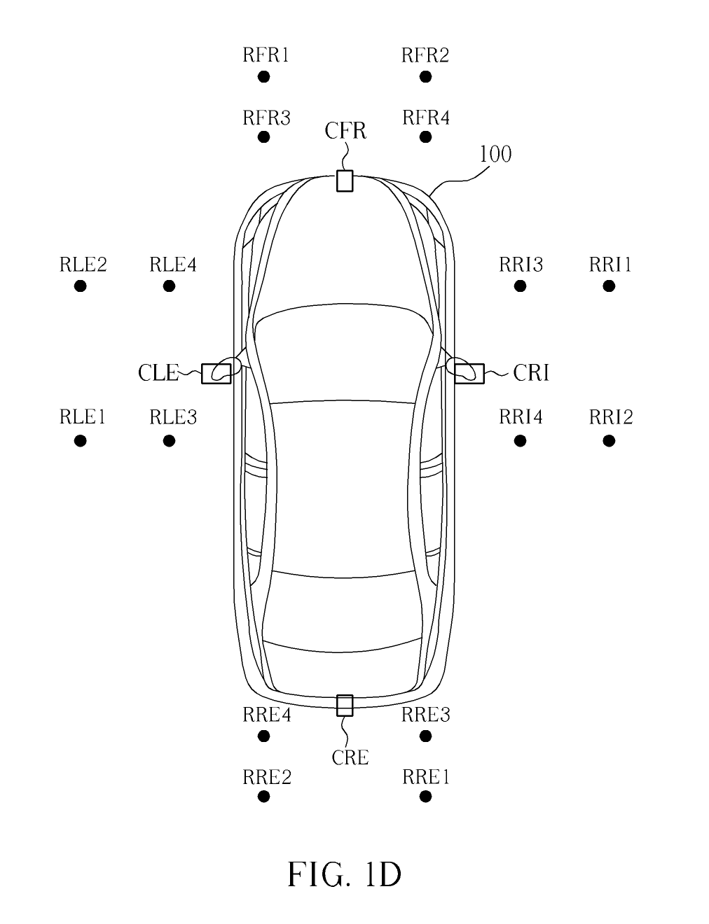

Please refer to FIG. 1A, FIG. 1B, FIG. 1C, and FIG. 1D. FIG. 1A, FIG. 1B, and FIG. 1C are diagrams illustrating size of a car 100 and location information of cameras CFR, CRE, CLE, CRI installed at front side, rear side, left side, and right side of the car 100, respectively, and FIG. 1D is a diagram illustrating setting a plurality of reference points corresponding to each camera of the cameras CFR, CRE, CLE, CRI according to the size of the car 100 and the location information of the cameras CFR, CRE, CLE, CRI, where the location information of the cameras CFR, CRE, CLE, CRI includes heights, locations, and installation angles of the cameras CFR, CRE, CLE, CRI, and the cameras CFR, CRE, CLE, CRI are fisheye cameras. The present invention is not limited to only installing one camera at the front side, the rear side, the left side, and the right side of the car 100, respectively. In addition, the car 100 can be any powered vehicle. As shown in FIG. 1A, the size of the car 100 includes width Y and length X of the car 100. As shown in FIG. 1A, FIG. 1B, and FIG. 1C, the location information of the camera CFR includes distances YFR1, YFR2, and a height HFR, the location information of the camera CRE includes distances YRE1, YRE2, and a height HRE, the location information of the camera CLE includes distances XLE1, XLE2, and a height HLE, and the location information of the camera CRI includes distances XRI1, XRI2, and a height HRI. In addition, as shown in FIG. 1B and FIG. 1C, the installation angle of the camera CFR is θFR, the installation angle of the camera CRE is θRE, the installation angles of the camera CLE are θLE and θ, and the installation angles of the camera CRI are θRI and θ. As shown in FIG. 1D, a user can set locations of reference points RFR1-RFR4 corresponding to the camera CFR, locations of reference points RRE1-RRE4 corresponding to the camera CRE, locations of reference points RLE1-RLE4 corresponding to the camera CLE, and locations of reference points RRI1-RRI4 corresponding to the camera CRI according to the size of the car 100, the location information, and the installation angles of the cameras CFR, CRE, CLE, CRI. The present invention is not limited to one camera corresponding to 4 reference points. That is to say, one camera can correspond to more than 4 reference points. In addition, the user can set a plurality of reference points corresponding to each camera according to a Y component, a U component and/or a V component, and red, green, and blue components of an object.

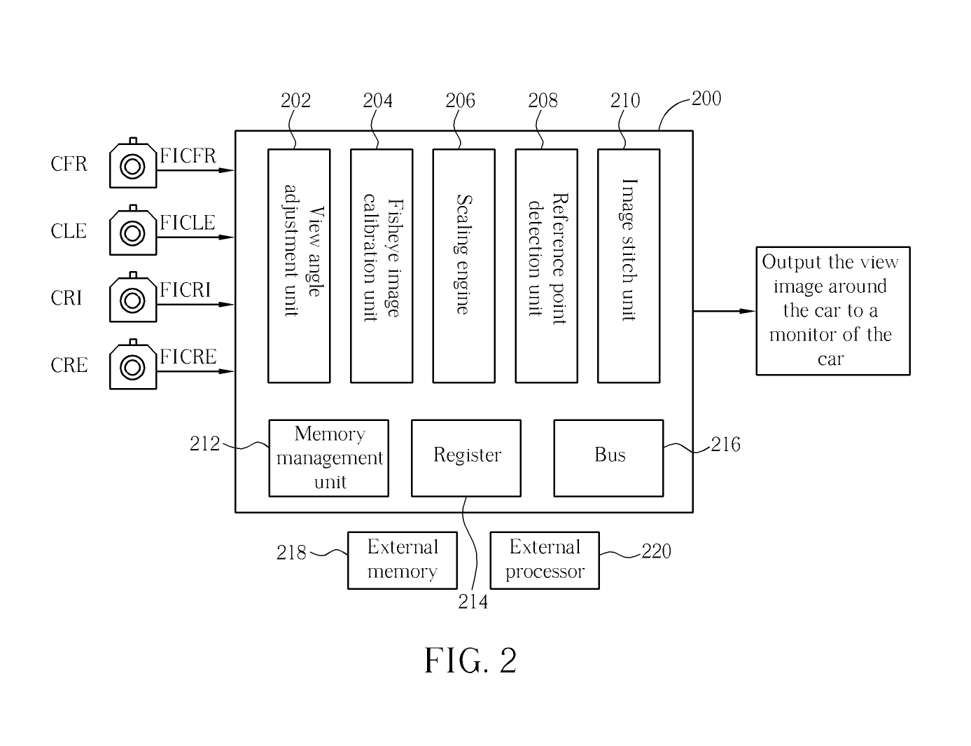

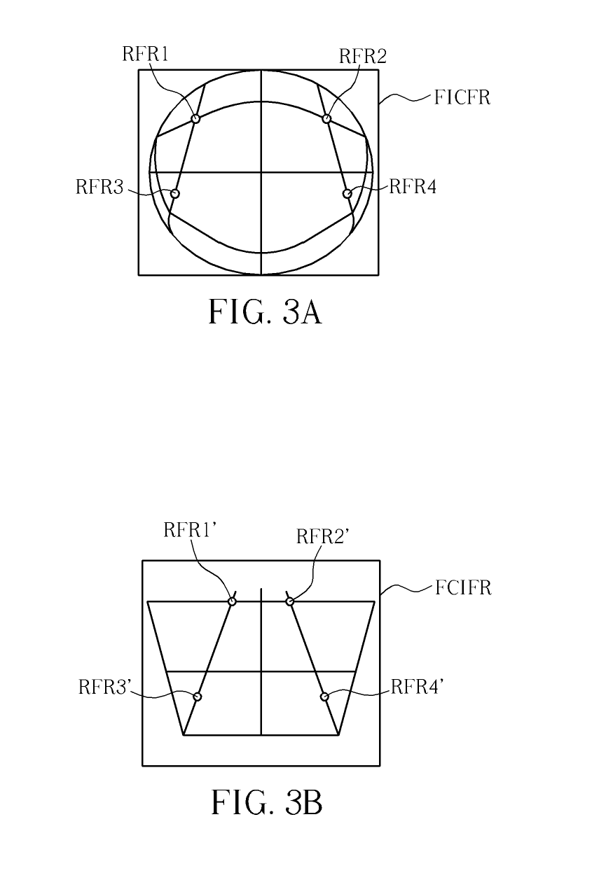

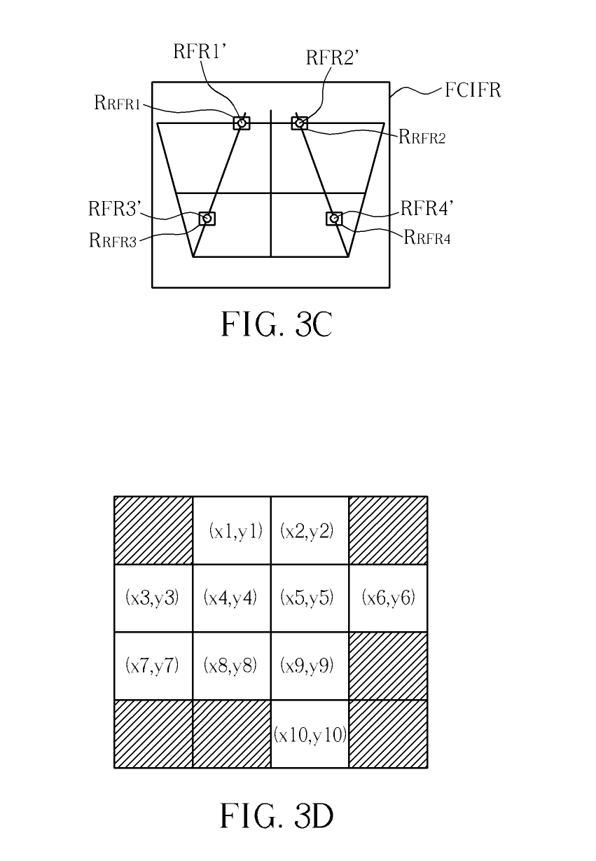

Please refer to FIG. 2. FIG. 2 is a diagram illustrating a calibration circuit 200 for automatically calibrating a view image around a car according to an embodiment. The calibration circuit 200 includes a view angle adjustment unit 202, a fisheye image calibration unit 204, a scaling engine 206, a reference point detection unit 208, an image stitch unit 210, a memory management unit 212, a register 214, and a bus 216. The cameras CFR, CRE, CLE, CRI installed at the front side, the rear side, the left side, and the right side of the car 100 capture fisheye images FICFR, FICRE, FICLE, FICRI, respectively, and transmit the fisheye images FICFR, FICRE, FICLE, FICRI to the view angle adjustment unit 202, where the fisheye images FICFR, FICRE, FICLE, FICRI include the plurality of reference points RFR1-RFR4, RRE1-RRE4, RLE1-RLE4, RRI1-RRI4 corresponding to the cameras CFR, CRE, CLE, CRI, respectively. The memory management unit 212 is used for managing and transmitting the fisheye images FICFR, FICRE, FICLE, FICRI received by the view angle adjustment unit 202 to an external memory 218. Please refer to FIG. 3A, FIG. 3B, FIG. 3C, and FIG. 3D. FIG. 3A is a diagram illustrating the camera CFR capturing the fisheye image FICFR including the reference points RFR1-RFR4 corresponding to the camera CFR, FIG. 3B is a diagram illustrating the fisheye image calibration unit 204 executing fisheye correction on the fisheye image FICFR to generate a corrected fisheye image FCIFR, FIG. 3C is a diagram illustrating the external processor 220 determining search regions R_{RFR1}-R_{RFR4} of reference points RFR1′-RFR4′ in the corrected fisheye image FCIFR, and FIG. 3D is a diagram illustrating the external processor 220 executing image binarization on the search region R_{RFR1} of the reference point RFR1′. Each camera of the present invention needs to correspond to at least four reference points. As shown in FIG. 3B, the corrected fisheye image FCIFR is scaled properly by the scaling engine 206. The reference point detection unit 208 is coupled to the scaling engine 206 for detecting the reference points RFR1′-RFR4′ included by the corrected fisheye image FCIFR, and transmitting the reference points RFR1′-RFR4′ to the external processor 220 through the bus 216, where the bus 216 is an I²C communication bus, or a serial peripheral interface bus. As shown in FIG. 3C, the user can determine size of the search region R_{RFR1} of the reference points RFR1′. After the search region R_{RFR1} of the reference points RFR1′ is determined, the external processor 220 executes the image binarization on the search region R_{RFR1} according to a predetermined luminance, where the user can determine the predetermined luminance. Because locations of the reference points RFR1′-RFR4′ on the corrected fisheye image FCIFR are 4 bright spots, a purpose of the image binarization is to reduce a burden of the external processor 220, and accelerate the external processor 220 to calculate coordinates of the locations of the reference points RFR1′-RFR4′. As shown in FIG. 3D, the search region R_{RFR1} has 16 pixels, where luminances of 10 pixels (white blocks) are higher than the predetermined luminance, and luminances of another 6 pixels (black blocks) are lower than the predetermined luminance. Therefore, the external processor 220 can calculate center of gravity coordinates (X1,Y1) according to coordinates of the 10 pixels with luminance higher than the predetermined luminance, equation (1), and equation (2), and can store the center of gravity coordinates (X1, Y1) of the reference points RFR1′ in the register 214.

X1=(x1+x2+x3+x4+x5+x6+x7+x8+x9+x10)/weight value W (1)

Y1=(y1+y2+y3+y4+y5+y6+y7+y8+y9+y10)/weight value W (2)

The weight value W is 10. The weight value W of the present invention can vary with luminance of the 16 pixels of the search region R_{RFR1}, and the center of gravity coordinates (X1,Y1) of the reference points RFR1′ are not limited to the above mentioned calculation method. Further, calculations of center of gravity coordinates (X2,Y2) corresponding to the reference points RFR2′, center of gravity coordinates (X3,Y3) corresponding to the reference points RFR3′, and center of gravity coordinates (X4,Y4) corresponding to the reference points RFR4′ are the same as the calculation of the center of gravity coordinates (X1,Y1) corresponding to the reference points RFR1′, so further description thereof is omitted for simplicity. In addition, FIG. 3A only takes the fisheye image FICFR captured by the camera CFR as an example, and subsequent operational principles of the cameras CRE, CLE, CRI are the same as those of the camera CFR, so further descriptions thereof are omitted for simplicity.

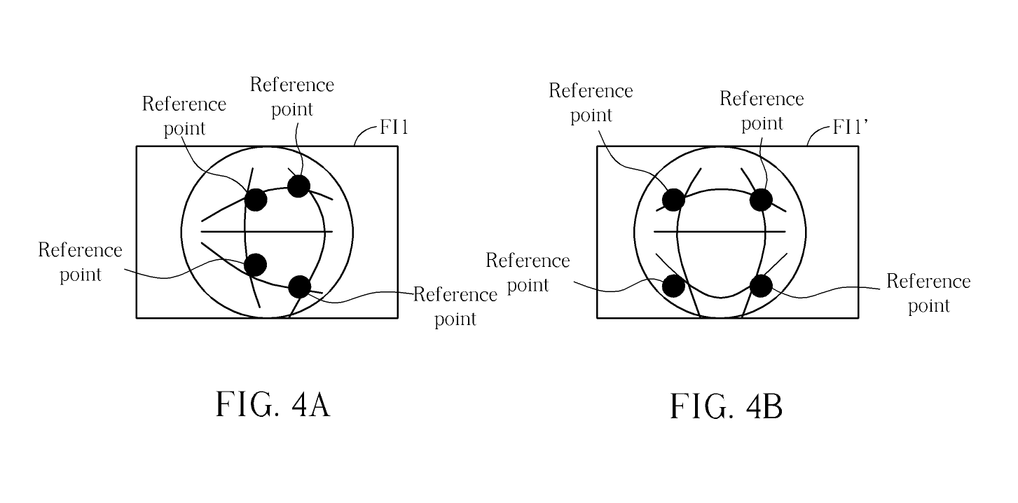

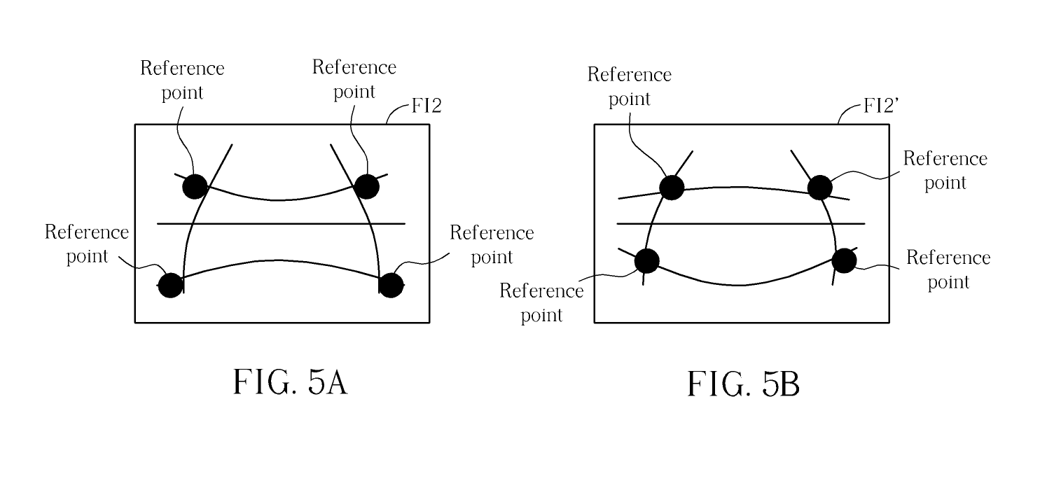

Please refer to FIG. 4A and FIG. 4B. FIG. 4A is a diagram illustrating a fisheye image FI1 captured by the camera CFR when a view angle of the camera CFR is located outside a predetermined view angle range, and FIG. 4B is a diagram illustrating the view angle adjustment unit 202 generating a fisheye image FI1′ by a view angle adjustment parameter corresponding to the camera CFR. After the external processor 220 calculates center of gravity coordinates corresponding to the plurality of reference points of the camera CFR, center of gravity coordinates corresponding to the plurality of reference points of the camera CRE, center of gravity coordinates corresponding to the plurality of reference points of the camera CLE, and center of gravity coordinates corresponding to the plurality of reference points of the camera CRI, the external processor 220 can determine whether view angles of the cameras CFR, CRE, CLE, CRI are located within the predetermined view angle range. As shown in FIG. 4A, the external processor 220 determines that the view angle of the camera CFR is located outside the predetermined view angle range according to the fisheye image FI1. Therefore, the external processor 220 generates the view angle adjustment parameter corresponding to the camera CFR according to the fisheye image FI1 and the center of gravity coordinates corresponding to the plurality of reference points of the camera CFR, and transmits the view angle adjustment parameter corresponding to the camera CFR to the register 214 through the bus 216. That is to say, the external processor 220 calculates the center of gravity coordinates corresponding to the plurality of reference points of the camera CFR according to the fisheye image FI1, and generates the view angle adjustment parameter corresponding to the camera CFR according to the center of gravity coordinates of the plurality of reference points of the camera CFR. Then, the view angle adjustment unit 202 can generate a fisheye image again according to the view angle adjustment parameter corresponding to the camera CFR. Thus, the calibration circuit 200 repeats the above mentioned steps until the view angle adjustment unit 202 generates a fisheye image such as the fisheye image FI1′ shown in FIG. 4B. However, the view angle of the camera CFR is still outside the predetermined view angle range. Further, FIG. 4A only takes the fisheye image FI1 captured by the camera CFR as an example, and subsequent operational principles of the cameras CRE, CLE, CRI are the same as those of the camera CFR, so further descriptions thereof are omitted for simplicity. In addition, the external processor 220 stores the view angle adjustment parameters corresponding to the cameras CFR, CRE, CLE, CRI in the register 214.

Please refer to FIG. 5A and FIG. 5B. FIG. 5A and FIG. 5B are diagrams illustrating the fisheye image calibration unit 204 executing the fisheye correction on a fisheye image captured by the camera CFR to generate non-ideal corrected fisheye images FI2, FI2′. In FIG. 3B, the corrected fisheye image FCIFR generated by the fisheye image calibration unit 204 according to a predetermined lens curvature parameter range is an ideal corrected fisheye image. As shown in FIG. 5A, the corrected fisheye image FI2 generated by the fisheye image calibration unit 204 according to a lens curvature parameter smaller than the predetermined lens curvature parameter range is a non-ideal corrected fisheye image. As shown in FIG. 5B, the corrected fisheye image FI2′ generated by the fisheye image calibration unit 204 according to a lens curvature parameter greater than the predetermined lens curvature parameter range is also a non-ideal corrected fisheye image. Therefore, the external processor 220 can correct the lens curvature parameter of the camera CFR according to the corrected fisheye images FI2, FI2′, and transmit the corrected lens curvature parameter of the camera CFR to the register 214 through the bus 216. That is to say, the external processor 220 calculates the center of gravity coordinates of the plurality of reference points corresponding to the camera CFR according to the corrected fisheye images FI2, FI2′, and corrects the lens curvature parameter of the camera CFR according to the center of gravity coordinates of the plurality of reference points. The fisheye image calibration unit 204 can generate a corrected fisheye image again according to the corrected lens curvature parameter of the camera CFR. Then, the calibration circuit 200 repeats the above mentioned steps until the fisheye image calibration unit 204 generates a corrected fisheye image as the ideal corrected fisheye image FCIFR shown in FIG. 3B. In addition, the external processor 220 determines that the lens curvature parameter of the camera CFR is within the predetermined lens curvature parameter range when a plurality of reference lines determined by the center of gravity coordinates of the plurality of reference points corresponding to the camera CFR in the corrected fisheye image FI2′ are straight lines; the external processor 220 determines that the lens curvature parameter of the camera CFR is outside the predetermined lens curvature parameter range when a plurality of reference lines determined by the center of gravity coordinates of the plurality of reference points corresponding to the camera CFR in the corrected fisheye image FI2′ are curves. Further, FIG. 5A and FIG. 5B only take the corrected fisheye images FI2 and FI2′ captured by the camera CFR as examples, and subsequent operational principles of the cameras CRE, CLE, CRI are the same as those of the camera CFR, so further descriptions thereof are omitted for simplicity.

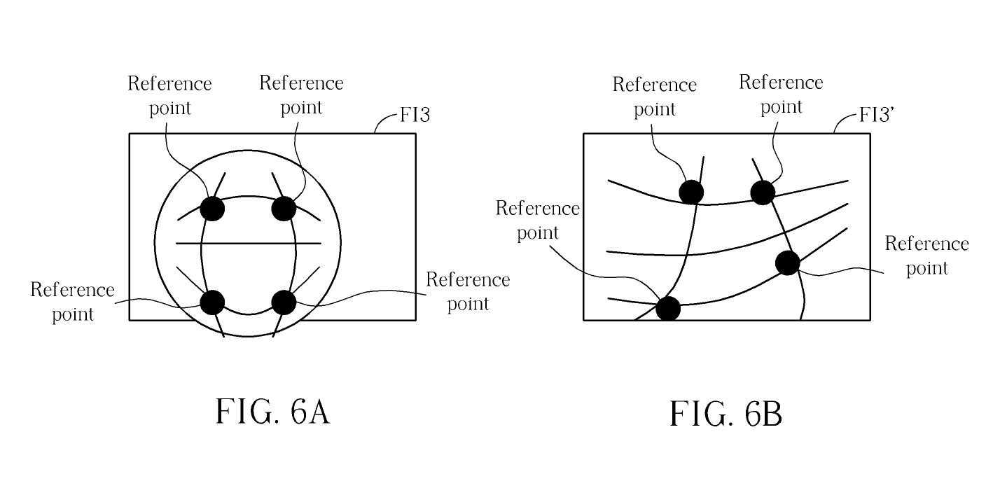

Please refer to FIG. 6A and FIG. 6B. FIG. 6A is a diagram illustrating a fisheye image FI3 captured by the camera CFR with a shifted image center, and FIG. 6B is a diagram illustrating the fisheye image calibration unit 204 executing the fisheye correction on the fisheye image FI3 to generate a corrected fisheye image FI3′. As shown in FIG. 6B, the corrected fisheye image FI3′ generated by the fisheye image calibration unit 204 according to the fisheye image FI3 captured by the camera CFR with the shifted image center is a non-ideal corrected fisheye image. Therefore, the external processor 220 can determine whether an image center of the camera CFR is located outside a predetermined range according to the corrected fisheye image FI3′. When the image center of the camera CFR is located outside the predetermined range, the external processor 220 can correct the image center of the camera CFR according to the corrected fisheye image FI3′, and transmit the corrected image center of the camera CFR to the register 214 through the bus 216. That is to say, the external processor 220 calculates the plurality of reference points corresponding to the camera CFR according to the corrected fisheye image FI3′, and corrects the image center of the camera CFR according to the plurality of reference points corresponding to the camera CFR. Then, the fisheye image calibration unit 204 can execute the fisheye correction on a fisheye image captured by the camera CFR again according to the corrected image center of the camera CFR to generate a corrected fisheye image. Thus, the calibration circuit 200 repeats the above mentioned steps until the fisheye image calibration unit 204 generates a corrected fisheye image as the ideal corrected fisheye image FCIFR shown in FIG. 3B. In addition, the external processor 220 determines that the image center of the camera CFR is located within the predetermined range when a plurality of reference lines determined by center of gravity coordinates of a plurality of reference points corresponding to the camera CFR in the corrected fisheye image FI3′ are straight lines; and, the external processor 220 determines that the image center of the camera CFR is located outside the predetermined range when a plurality of reference lines determined by center of gravity coordinates of a plurality of reference points corresponding to the camera CFR in the corrected fisheye image FI3′ are curves. Further, FIG. 6A and FIG. 6B only take the fisheye image FI3 captured by the camera CFR and the corrected fisheye image FI3′ as examples, and subsequent operational principles of the cameras CRE, CLE, CRI are the same as those of the camera CFR, so further descriptions thereof are omitted for simplicity.

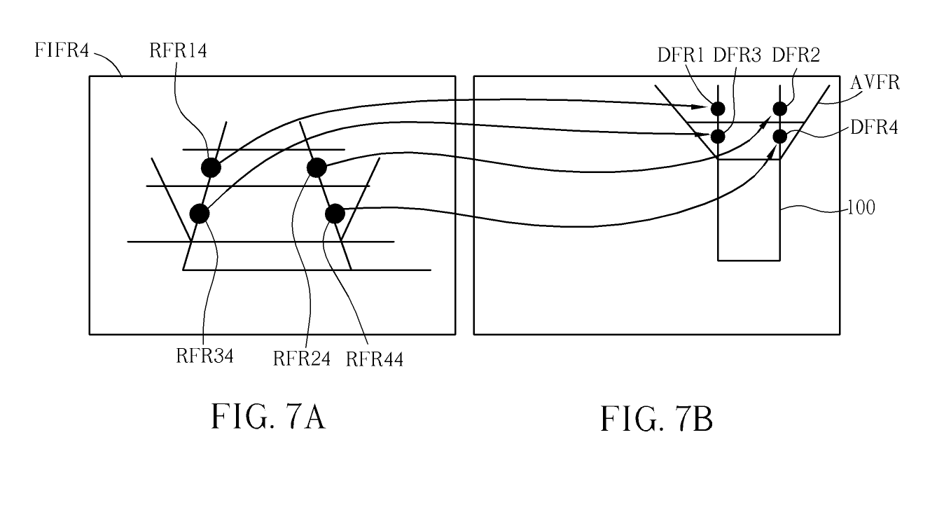

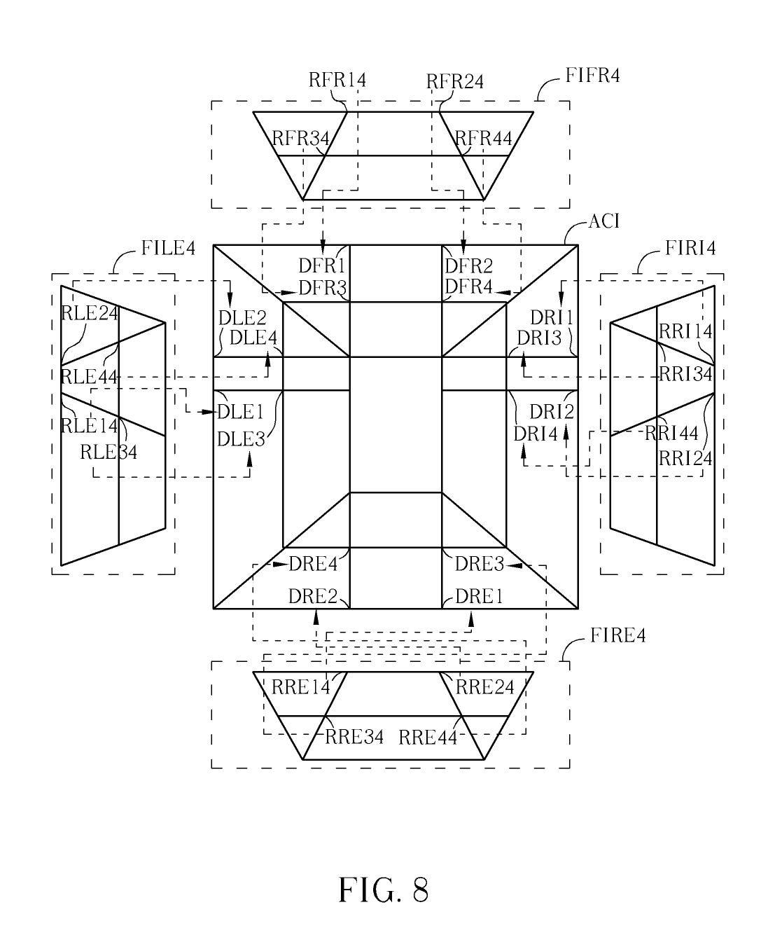

Please refer to FIG. 7A and FIG. 7B. FIG. 7A and FIG. 7B are diagrams illustrating the image stitch unit 210 generating a view image AVFR corresponding to the front side of car 100 according to a corrected fisheye image FIFR4 corresponding to the camera CFR and a first image projection equation, where the image stitch unit 210 is coupled to the reference point detection unit 208, and the view angle, the lens curvature parameter, and the image center of the camera CFR are corrected. As shown in FIG. 7A, the image stitch unit 210 projects reference points RFR14-RFR44 of the corrected fisheye image FIFR4 to target points DFR1-DFR4 of the view image AVFR shown in FIG. 7B, respectively, according to the first image projection equation. Similarly, the image stitch unit 210 projects reference points RRE14-RRE44 of a corrected fisheye image FIRE4 to target points DRE1-DRE4 of a view image AVRE, respectively, according to the second image projection equation; the image stitch unit 210 projects reference points RLE14-RLE44 of a corrected fisheye image FILE4 to target points DLE1-DLE4 of a view image AVLE, respectively, according to the third image projection equation; and, the image stitch unit 210 projects reference points RRI14-RRI44 of a corrected fisheye image FIRI4 to target points DRI1-DRI4 of a view image AVRI, respectively, according to the fourth image projection equation. In addition, FIG. 7A and FIG. 7B only take the fisheye image FIFR4 captured by the camera CFR and the view image AVFR as examples, and subsequent operational principles of the cameras CRE, CLE, CRI are the same as those of the camera CFR, so further descriptions thereof are omitted for simplicity. Please refer to FIG. 8. FIG. 8 is a diagram illustrating the image stitch unit 210 generating a view image ACI around the car 100 according to the view image AVFR, the view image AVRE, the view image AVLE, and the view image AVRI. After the image stitch unit 210 generates the view image ACI around the car 100, the image stitch unit 210 outputs the view image ACI around the car 100 to a monitor of the car 100.

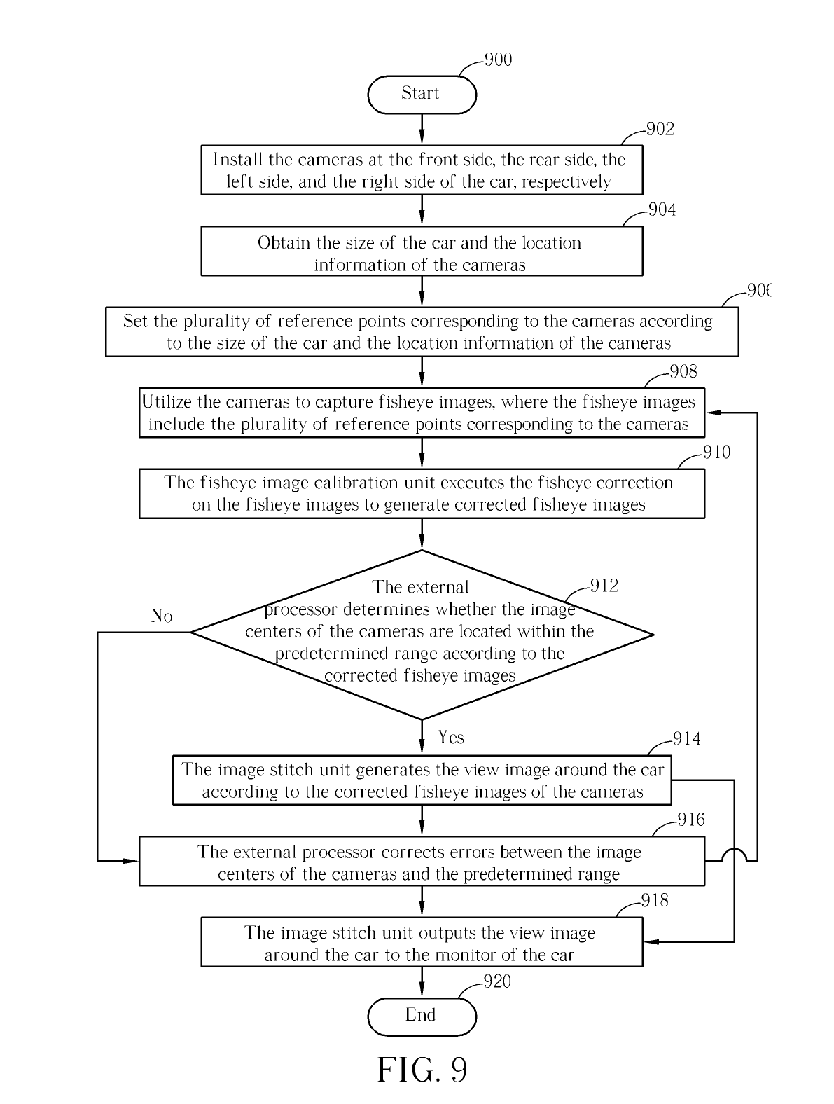

Please refer to FIG. 9. FIG. 9 is a flowchart illustrating a method of automatically calibrating a view image around a car according to another embodiment. The method in FIG. 9 uses the car 100 in FIG. 1 and the calibration circuit 200 in FIG. 2 for illustration. Detailed steps are as follows:

Step 900: Start.

Step 902: Install the cameras CFR, CRE, CLE, CRI at the front side, the rear side, the left side, and the right side of the car 100, respectively.

Step 904: Obtain the size of the car 100 and the location information of the cameras CFR, CRE, CLE, CRI.

Step 906: Set the plurality of reference points corresponding to the cameras CFR, CRE, CLE, CRI, respectively, according to the size of the car 100 and the location information of the cameras CFR, CRE, CLE, CRI.

Step 908: Utilize the cameras CFR, CRE, CLE, CRI to capture fisheye images FIFR5, FIRE5, FILE5, FIRI5, respectively, where the fisheye images FIFR5, FIRE5, FILE5, FIRI5 include the plurality of reference points corresponding to the cameras CFR, CRE, CLE, CRI, respectively.

Step 910: The fisheye image calibration unit 204 executes the fisheye correction on the fisheye images FIFR5, FIRE5, FILE5, FIRI5, respectively, to generate corrected fisheye images FCIFR5, FCIRE5, FCILE5, FCIRI5.

Step 912: The external processor 220 determines whether the image centers of the cameras CFR, CRE, CLE, CRI are located within the predetermined range according to the corrected fisheye images FCIFR5, FCIRE5, FCILE5, FCIRI5. If yes, go to Step 914; if no, go to Step 916.

Step 914: The image stitch unit 210 generates the view image ACI around the car 100 according to the corrected fisheye images FCIFR5, FCIRE5, FCILE5, FCIRI5 of the cameras CFR, CRE, CLE, CRI; go to Step 918.

Step 916: The external processor 220 corrects errors between the image centers of the cameras CFR, CRE, CLE, CRI and the predetermined range; go to Step 908.

Step 918: The image stitch unit 210 outputs the view image ACI around the car 100 to the monitor of the car 100.

Step 920: End.

In Step 904, the location information of the cameras CFR, CRE, CLE, CRI includes the heights and the installation angles of the cameras CFR, CRE, CLE, CRI. In Step 912, the external processor 220 can determine the image centers of the cameras CFR, CRE, CLE, CRI are located within the predetermined range when a plurality of reference lines determined by center of gravity coordinates of a plurality of reference points corresponding to the cameras CFR, CRE, CLE, CRI in the corrected fisheye images FCIFR5, FCIRE5, FCILE5, FCIRI5, respectively, are straight lines, and the external processor 220 can determine the image centers of the cameras CFR, CRE, CLE, CRI are located outside the predetermined range when a plurality of reference lines determined by the center of gravity coordinates of the plurality of reference points corresponding to the cameras CFR, CRE, CLE, CRI in the corrected fisheye images FCIFR5, FCIRE5, FCILE5, FCIRI5, respectively, are curves. In Step 914, the image stitch unit 210 generates the view image ACI around the car 100 according to the corrected fisheye images FCIFR5, FCIRE5, FCILE5, FCIRI5, the first image projection equation, the second image projection equation, the third image projection equation, and the fourth image projection equation. In Step 916, when the image centers of the cameras CFR, CRE, CLE, CRI are located outside the predetermined range, the external processor 220 corrects the errors between the image centers of the cameras CFR, CRE, CLE, CRI and the predetermined range according to the corrected fisheye images FCIFR5, FCIRE5, FCILE5, FCIRI5. That is to say, the external processor 220 calculates the center of gravity coordinates of the plurality of reference points corresponding to the cameras CFR, CRE, CLE, CRI in the corrected fisheye image FCIFR5, FCIRE5, FCILE5, FCIRI5, respectively, according to the corrected fisheye images FCIFR5, FCIRE5, FCILE5, FCIRI5, and corrects the errors between the image centers of the cameras CFR, CRE, CLE, CRI and the predetermined range according to the center of gravity coordinates of the plurality of reference points corresponding to the cameras CFR, CRE, CLE, CRI in the corrected fisheye images FCIFR5, FCIRE5, FCILE5, FCIRI5, respectively.

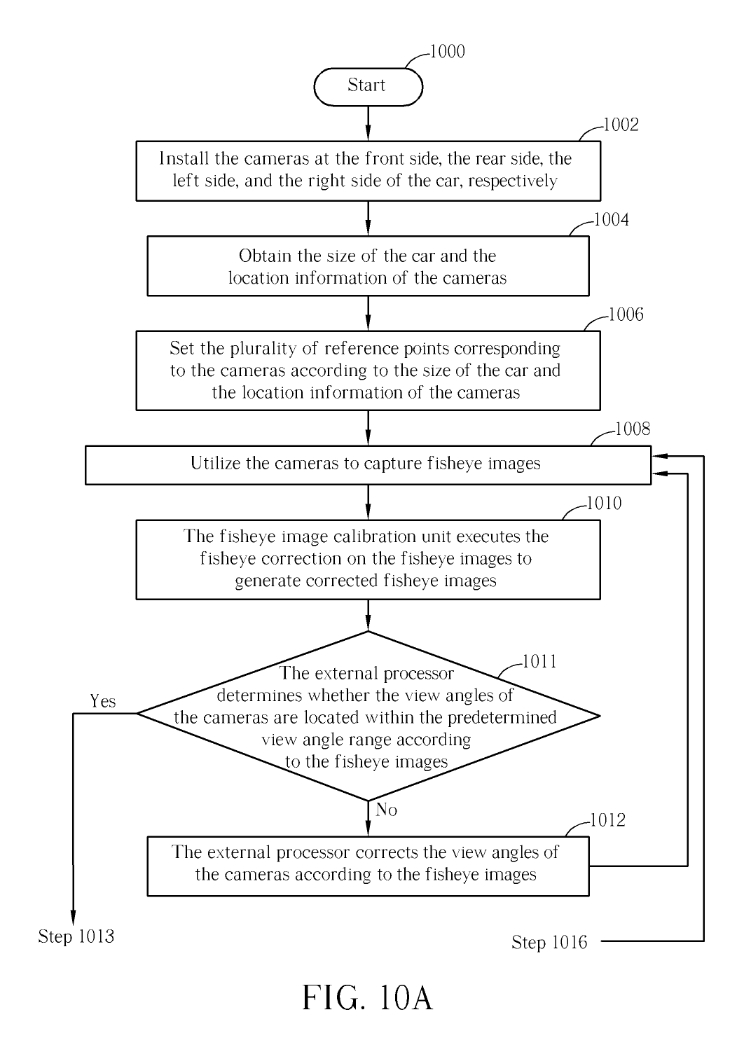

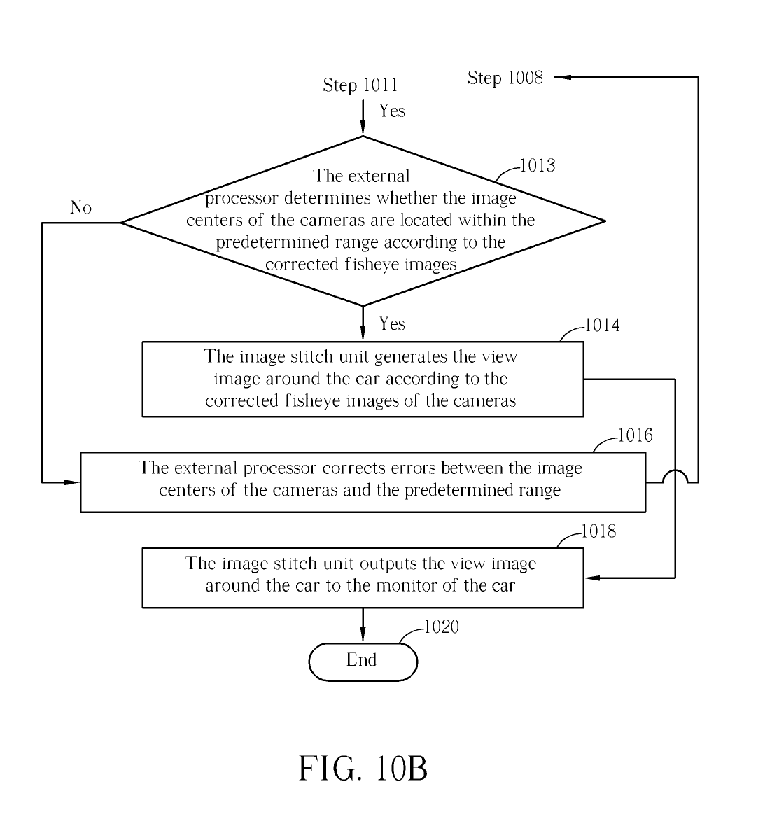

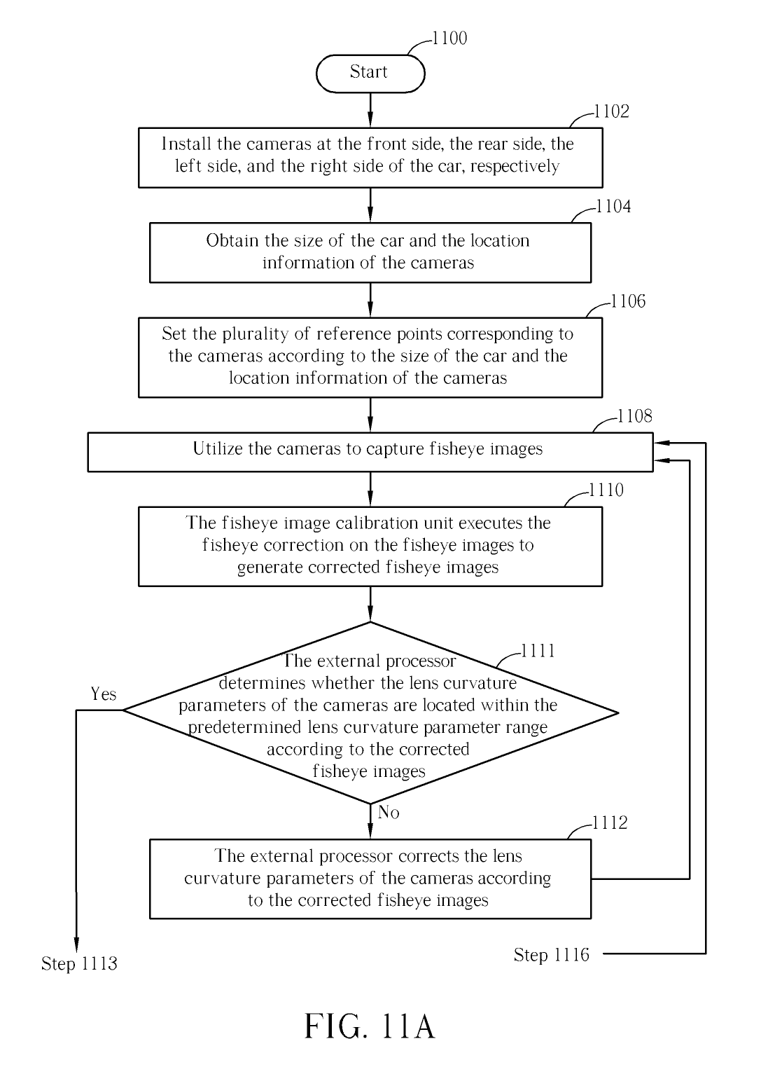

Please refer to FIG. 10A and FIG. 10B. FIG. 10A and FIG. 10B are flowcharts illustrating a method of automatically calibrating a view image around a car according to another embodiment. The method in FIG. 10A and FIG. 10B uses the car 100 in FIG. 1 and the calibration circuit 200 in FIG. 2 for illustration. Detailed steps are as follows:

Step 1000: Start.

Step 1002: Install the cameras CFR, CRE, CLE, CRI at the front side, the rear side, the left side, and the right side of the car 100, respectively.

Step 1004: Obtain the size of the car 100 and the location information of the cameras CFR, CRE, CLE, CRI.

Step 1006: Set the plurality of reference points corresponding to the cameras CFR, CRE, CLE, CRI, respectively, according to the size of the car 100 and the location information of the cameras CFR, CRE, CLE, CRI.

Step 1008: Utilize the cameras CFR, CRE, CLE, CRI to capture fisheye images FIFR5, FIRE5, FILE5, FIRI5, respectively, where the fisheye images FIFR5, FIRE5, FILE5, FIRI5 include the plurality of reference points corresponding to the cameras CFR, CRE, CLE, CRI, respectively.

Step 1010: The fisheye image calibration unit 204 executes the fisheye correction on the fisheye images FIFR5, FIRE5, FILE5, FIRI5, respectively, to generate corrected fisheye images FCIFR5, FCIRE5, FCILE5, FCIRI5.

Step 1011: The external processor 220 determines whether the view angles of the cameras CFR, CRE, CLE, CRI are located within the predetermined view angle range according to the fisheye images FIFR5, FIRE5, FILE5, FIRI5. If yes, go to Step 1013; if no, go to Step 1012.

Step 1012: The external processor 220 corrects the view angles of the cameras CFR, CRE, CLE, CRI according to the fisheye images FIFR5, FIRE5, FILE5, FIRI5; go to Step 1008.

Step 1013: The external processor 220 determines whether the image centers of the cameras CFR, CRE, CLE, CRI are located within the predetermined range according to the corrected fisheye images FCIFR5, FCIRE5, FCILE5, FCIRI5. If yes, go to Step 1014; if no, go to Step 1016.

Step 1014: The image stitch unit 210 generates the view image ACI around the car 100 according to the corrected fisheye images FCIFR5, FCIRE5, FCILE5, FCIRI5 of the cameras CFR, CRE, CLE, CRI; go to Step 1018.

Step 1016: The external processor 220 corrects errors between the image centers of the cameras CFR, CRE, CLE, CRI and the predetermined range; go to Step 1008.

Step 1018: The image stitch unit 210 outputs the view image ACI around the car 100 to the monitor of the car 100.

Step 1020: End.

A difference between the embodiment in FIG. 10A and FIG. 10B and the embodiment in FIG. 9 is that in Step 1011, the external processor 220 determines whether the view angles of the cameras CFR, CRE, CLE, CRI are located within the predetermined view angle range according to the fisheye images FIFR5, FIRE5, FILE5, FIRI5. That is to say, after the external processor 220 calculates center of gravity coordinates of the plurality of reference points corresponding to the camera CFR, center of gravity coordinates of the plurality of reference points corresponding to the camera CRE, center of gravity coordinates of the plurality of reference points corresponding to the camera CLE, and center of gravity coordinates of the plurality of reference points corresponding to the camera CRI according to the corrected fisheye images FCIFR5, FCIRE5, FCILE5, FCIRI5, the external processor 220 can determine whether the view angles of the cameras CFR, CRE, CLE, CRI are located within the predetermined view angle range. In addition, in Step 1012, the external processor 220 corrects the view angles of the cameras CFR, CRE, CLE, CRI according to the fisheye images FIFR5, FIRE5, FILE5, FIRI5 and center of gravity coordinates of the plurality of reference points corresponding to the cameras CFR, CRE, CLE, CRI, respectively. Further, subsequent operational principles of the embodiment in FIG. 10A and FIG. 10B are the same as those of the embodiment in FIG. 9, so further description thereof is omitted for simplicity.

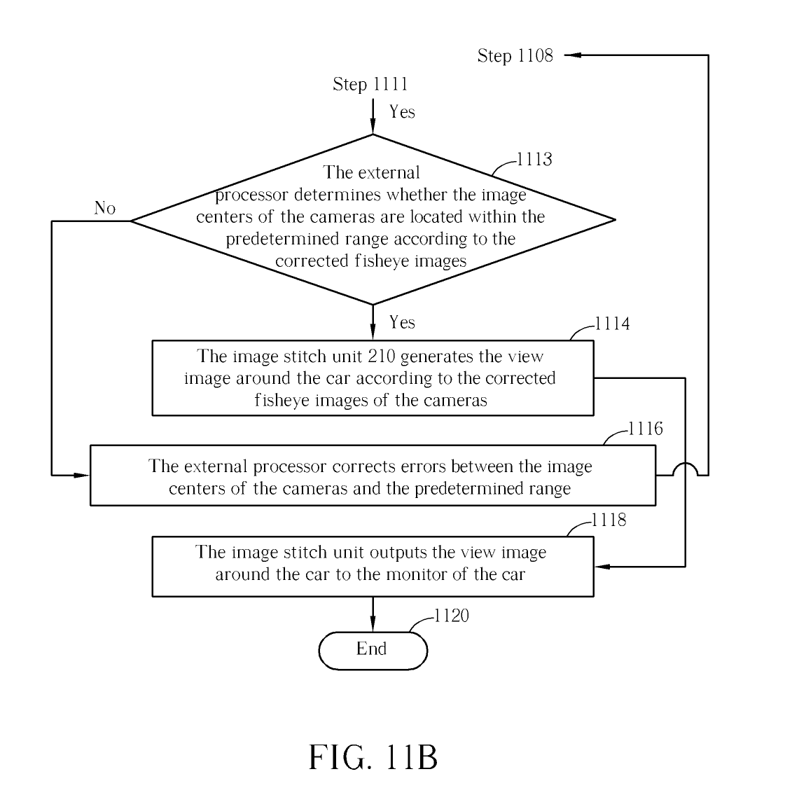

Please refer to FIG. 11A and FIG. 11B. FIG. 11A and FIG. 11B are flowcharts illustrating a method of automatically calibrating a view image around a car according to another embodiment. The method in FIG. 11A and FIG. 11B uses the car 100 in FIG. 1 and the calibration circuit 200 in FIG. 2 for illustration. Detailed steps are as follows:

Step 1100: Start.

Step 1102: Install the cameras CFR, CRE, CLE, CRI at the front side, the rear side, the left side, and the right side of the car 100, respectively.

Step 1104: Obtain the size of the car 100 and the location information of the cameras CFR, CRE, CLE, CRI.

Step 1106: Set the plurality of reference points corresponding to the cameras CFR, CRE, CLE, CRI, respectively, according to the size of the car 100 and the location information of the cameras CFR, CRE, CLE, CRI.

Step 1108: Utilize the cameras CFR, CRE, CLE, CRI to capture fisheye images FIFR5, FIRE5, FILE5, FIRI5, respectively, where the fisheye images FIFR5, FIRE5, FILE5, FIRI5 include the plurality of reference points corresponding to the cameras CFR, CRE, CLE, CRI, respectively.

Step 1110: The fisheye image calibration unit 204 executes the fisheye correction on the fisheye images FIFR5, FIRE5, FILE5, FIRI5, respectively, to generate corrected fisheye images FCIFR5, FCIRE5, FCILE5, FCIRI5.

Step 1111: The external processor 220 determines whether the lens curvature parameters of the cameras CFR, CRE, CLE, CRI are located within the predetermined lens curvature parameter range according to the corrected fisheye images FCIFR5, FCIRE5, FCILE5, FCIRI5. If yes, go to Step 1113; if no, go to Step 1112.

Step 1112: The external processor 220 corrects the lens curvature parameters of the cameras CFR, CRE, CLE, CRI according to the corrected fisheye images FCIFR5, FCIRE5, FCILE5, FCIRI5; go to Step 1108.

Step 1113: The external processor 220 determines whether the image centers of the cameras CFR, CRE, CLE, CRI are located within the predetermined range according to the corrected fisheye images FCIFR5, FCIRE5, FCILE5, FCIRI5. If yes, go to Step 1114; if no, go to Step 1116.

Step 1114: The image stitch unit 210 generates the view image ACI around the car 100 according to the corrected fisheye images FCIFR5, FCIRE5, FCILE5, FCIRI5 of the cameras CFR, CRE, CLE, CRI; go to Step 1118.

Step 1116: The external processor 220 corrects errors between the image centers of the cameras CFR, CRE, CLE, CRI and the predetermined range; go to Step 1108.

Step 1118: The image stitch unit 210 outputs the view image ACI around the car 100 to the monitor of the car 100.

Step 1120: End.

A difference between the embodiment in FIG. 11A and FIG. 11B and the embodiment in FIG. 9 is that in Step 1111, the external processor 220 determines whether the lens curvature parameters of the cameras CFR, CRE, CLE, CRI are located within the predetermined lens curvature parameter range according to the fisheye images FIFR5, FIRE5, FILE5, FIRI5. That is to say, after the external processor 220 calculates center of gravity coordinates of the plurality of reference points corresponding to the camera CFR, center of gravity coordinates of the plurality of reference points corresponding to the camera CRE, center of gravity coordinates of the plurality of reference points corresponding to the camera CLE, and center of gravity coordinates of the plurality of reference points corresponding to the camera CRI according to the corrected fisheye images FCIFR5, FCIRE5, FCILE5, FCIRI5, the external processor 220 can determine whether the lens curvature parameters of the cameras CFR, CRE, CLE, CRI are located within the predetermined lens curvature parameter range. In addition, in Step 1112, the external processor 220 corrects the lens curvature parameters of the cameras CFR, CRE, CLE, CRI according to the fisheye images FIFR5, FIRE5, FILE5, FIRI5 and center of gravity coordinates of the plurality of reference points corresponding to the cameras CFR, CRE, CLE, CRI, respectively. Further, subsequent operational principles of the embodiment in FIG. 11A and FIG. 11B are the same as those of the embodiment in FIG. 9, so further description thereof is omitted for simplicity.

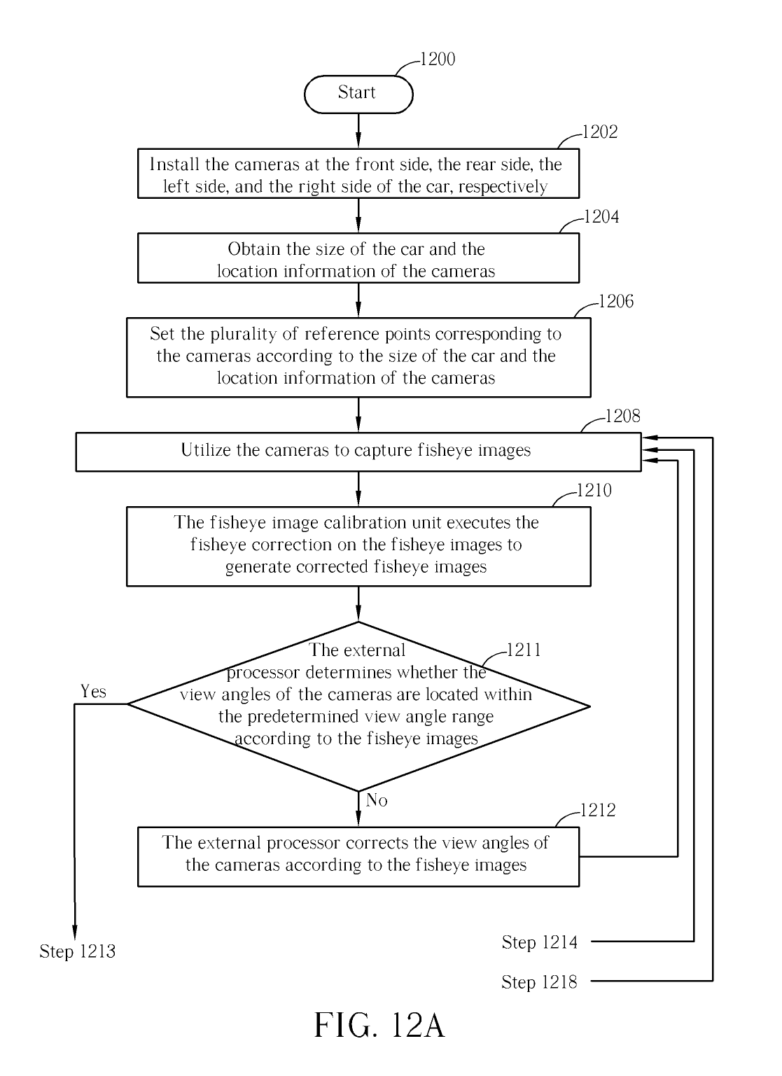

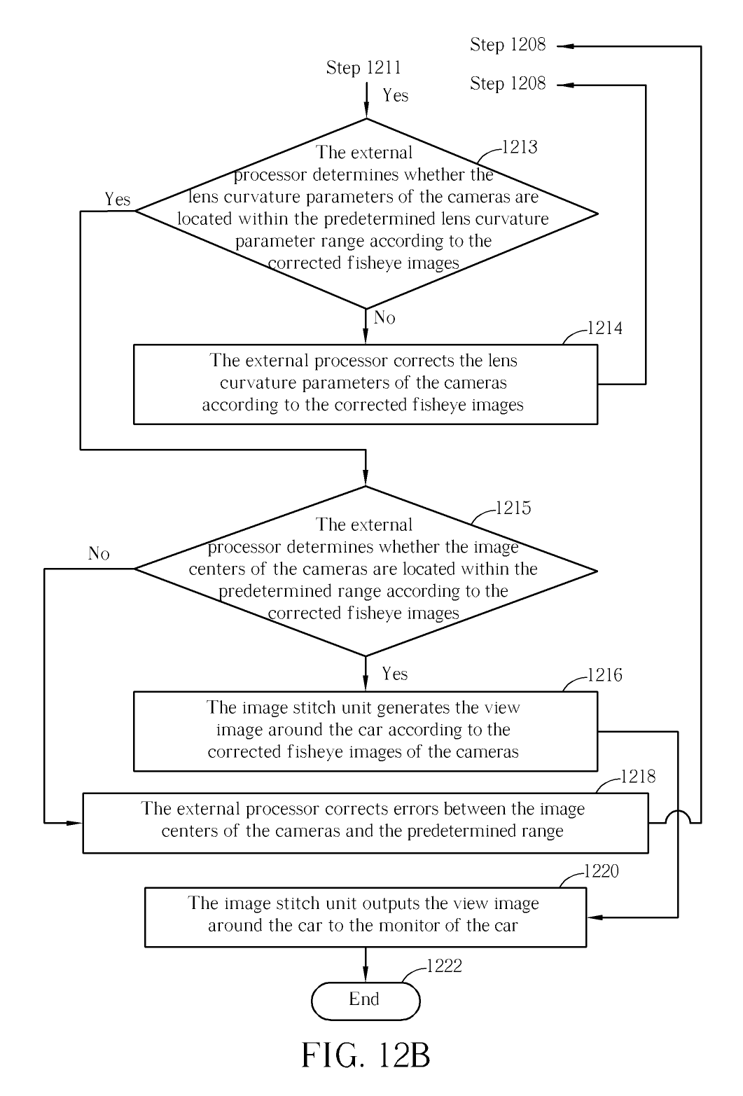

Please refer to FIG. 12A and FIG. 12B. FIG. 12A and FIG. 12B are flowcharts illustrating a method of automatically calibrating a view image around a car according to another embodiment. The method in FIG. 12A and FIG. 12B uses the car 100 in FIG. 1 and the calibration circuit 200 in FIG. 2 for illustration. Detailed steps are as follows:

Step 1200: Start.

Step 1202: Install the cameras CFR, CRE, CLE, CRI at the front side, the rear side, the left side, and the right side of the car 100, respectively.

Step 1204: Obtain the size of the car 100 and the location information of the cameras CFR, CRE, CLE, CRI.

Step 1206: Set the plurality of reference points corresponding to the cameras CFR, CRE, CLE, CRI, respectively, according to the size of the car 100 and the location information of the cameras CFR, CRE, CLE, CRI.

Step 1208: Utilize the cameras CFR, CRE, CLE, CRI to capture fisheye images FIFR5, FIRE5, FILE5, FIRI5, respectively, where the fisheye images FIFR5, FIRE5, FILE5, FIRI5 include the plurality of reference points corresponding to the cameras CFR, CRE, CLE, CRI, respectively.

Step 1210: The fisheye image calibration unit 204 executes the fisheye correction on the fisheye images FIFR5, FIRE5, FILE5, FIRI5, respectively, to generate corrected fisheye images FCIFR5, FCIRE5, FCILE5, FCIRI5.

Step 1211: The external processor 220 determines whether the view angles of the cameras CFR, CRE, CLE, CRI are located within the predetermined view angle range according to the fisheye images FIFR5, FIRE5, FILE5, FIRI5. If yes, go to Step 1213; if no, go to Step 1212.

Step 1212: The external processor 220 corrects the view angles of the cameras CFR, CRE, CLE, CRI according to the fisheye images FIFR5, FIRE5, FILE5, FIRI5; go to Step 1208.

Step 1213: The external processor 220 determines whether the lens curvature parameters of the cameras CFR, CRE, CLE, CRI are located within the predetermined lens curvature parameter range according to the corrected fisheye images FCIFR5, FCIRE5, FCILE5, FCIRI5. If yes, go to Step 1215; if no, go to Step 1214.

Step 1214: The external processor 220 corrects the lens curvature parameters of the cameras CFR, CRE, CLE, CRI according to the corrected fisheye images FCIFR5, FCIRE5, FCILE5, FCIRI5; go to Step 1208.

Step 1215: The external processor 220 determines whether the image centers of the cameras CFR, CRE, CLE, CRI are located within the predetermined range according to the corrected fisheye images FCIFR5, FCIRE5, FCILE5, FCIRI5. If yes, go to Step 1216; if no, go to Step 1218.

Step 1216: The image stitch unit 210 generates the view image ACI around the car 100 according to the corrected fisheye images FCIFR5, FCIRE5, FCILE5, FCIRI5 of the cameras CFR, CRE, CLE, CRI; go to Step 1220.

Step 1218: The external processor 220 corrects errors between the image centers of the cameras CFR, CRE, CLE, CRI and the predetermined range; go to Step 1208.

Step 1220: The image stitch unit 210 outputs the view image ACI around the car 100 to the monitor of the car 100.

Step 1222: End.

A difference between the embodiment in FIG. 12A and FIG. 12B and the embodiment in FIG. 11A and FIG. 11B is that in Step 1211, the external processor 220 determines whether the view angles of the cameras CFR, CRE, CLE, CRI are located within the predetermined view angle range according to the fisheye images FIFR5, FIRE5, FILE5, FIRI5. That is to say, after the external processor 220 calculates center of gravity coordinates of the plurality of reference points corresponding to the camera CFR, center of gravity coordinates of the plurality of reference points corresponding to the camera CRE, center of gravity coordinates of the plurality of reference points corresponding to the camera CLE, and center of gravity coordinates of the plurality of reference points corresponding to the camera CRI according to the corrected fisheye images FCIFR5, FCIRE5, FCILE5, FCIRI5, the external processor 220 can determine whether the view angles of the cameras CFR, CRE, CLE, CRI are located within the predetermined view angle range. In addition, in Step 1212, the external processor 220 corrects the view angles of the cameras CFR, CRE, CLE, CRI according to the fisheye images FIFR5, FIRE5, FILE5, FIRI5 and center of gravity coordinates of the plurality of reference points corresponding to the cameras CFR, CRE, CLE, CRI, respectively. Further, subsequent operational principles of the embodiment in FIG. 12A and FIG. 12B are the same as those of the embodiment in FIG. 11A and FIG. 11B, so further description thereof is omitted for simplicity.

To sum up, the calibration circuit for automatically calibrating the view image around the car and method thereof set a plurality of reference points corresponding to each camera of the cameras installed at the front side, the rear side, the left side, and the right side of the car, respectively, according to the size of the car and the location information of the cameras. Then, the calibration circuit and method thereof utilize each camera of the cameras to capture a fisheye image including the plurality of reference points corresponding to each camera of the cameras, and generate a corresponding corrected fisheye image according to the fisheye image corresponding to each camera of the cameras. Therefore, the present invention can rapidly correct an image center, a lens curvature parameter, and a view angle adjustment parameter of each camera according to the corrected fisheye image corresponding to each camera. Thus, the present invention can mass produce cars that provide a real time view image around a car rapidly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of automatically calibrating a view image around a car, the method comprising:
installing at least one camera at front side, rear side, left side, and right side of the car, respectively;
obtaining a size of the car and location information of the at least four cameras;
setting a plurality of reference points corresponding to each camera of the at least four cameras according to the size of the car and the location information of the at least four cameras;
utilizing one camera of the at least four cameras to capture a fisheye image including the plurality of reference points corresponding to the one camera;
executing fisheye correction on the fisheye image to generate a corrected fisheye image;
determining whether an image center of the one camera is located within a predetermined range according to the corrected fisheye image; and
performing a corresponding operation according to a determination result.

2. The method of claim 1, wherein performing the corresponding operation according to the determination result is generating the view image around the car according to corrected fisheye images of the at least four cameras and outputting the view image around the car to a car monitor when the image center of the camera is located within the predetermined range.

3. The method of claim 2, wherein generating the view image around the car according to the corrected fisheye images of the at least four cameras comprises:
generating a view image corresponding to the front side of the car according to the corrected fisheye image of at least one camera of the front side of the car and a first image projection equation;
generating a view image corresponding to the rear side of the car according to the corrected fisheye image of at least one camera of the rear side of the car and a second image projection equation;
generating a view image corresponding to the left side of the car according to the corrected fisheye image of at least one camera of the left side of the car and a third image projection equation;
generating a view image corresponding to the right side of the car according to the corrected fisheye image of at least one camera of the right side of the car and a fourth image projection equation; and
stitching the view image corresponding to the front side of the car, the view image corresponding to the rear side of the car, the view image corresponding to the left side of the car, and the view image corresponding to the right side of the car to generate the view image around the car, and outputting the view image around the car to the car monitor.

4. The method of claim 1, wherein performing the corresponding operation according to the determination result is utilizing an external processor to correct an error between the image center of the camera and the predetermined range when the image center of the camera is located outside the predetermined range, and the camera capturing an image including the plurality of reference points corresponding to the camera according to the corrected image center of the camera.

5. The method of claim 1, wherein the image center of the camera is determined to be located within the predetermined range when a plurality of reference lines determined by image locations of the plurality of reference points corresponding to the camera on the corrected fisheye image are straight lines.

6. The method of claim 1, wherein the image center of the camera is determined to be located outside the predetermined range when a plurality of reference lines determined by image locations of the plurality of reference points corresponding to the camera on the corrected fisheye image are curves.

7. The method of claim 1, further comprising:
adjusting the fisheye image according to a view angle adjustment parameter corresponding to the camera.

8. The method of claim 1, further comprising:
adjusting a lens curvature parameter of the camera according to the corrected fisheye image.

9. The method of claim 1, wherein the location information of the at least four cameras includes heights and installation angles of the at least four cameras.

10. The method of claim 1, wherein setting the plurality of reference points corresponding to the camera is setting the plurality of reference points corresponding to the camera according to a Y component of an object.

11. The method of claim 1, wherein setting the plurality of reference points corresponding to the camera is setting the plurality of reference points corresponding to the camera according to a U component and/or a V component of an object.

12. The method of claim 1, wherein setting the plurality of reference points corresponding to the camera is setting the plurality of reference points corresponding to the camera according to red, green, and blue components of an object.

13. A calibration circuit for automatically calibrating a view image around a car, the calibration circuit comprising:
a view angle adjustment unit for receiving fisheye images captured by at least one camera installed at front side, rear side, left side, and right side of a car, respectively, and adjusting the fisheye images captured by the at least four cameras according to a view angle adjustment parameter;
a fisheye image calibration unit for executing fisheye correction on a fisheye image captured by each camera of the at least four cameras to generate a corrected fisheye image, wherein the fisheye image includes a plurality of reference points corresponding to the camera;
a scaling engine coupled to the fisheye image calibration unit for scaling the corrected fisheye image;
a reference point detection unit coupled to the scaling engine for detecting a plurality of reference points included by the scaled corrected fisheye image, and transmitting the plurality of reference points included by the scaled corrected fisheye image to an external processor through a bus; and
an image stitch unit coupled to the reference point detection unit for generating a view image corresponding to the front side of the car according to the corrected fisheye image of at least one camera corresponding to the front side of the car and a first image projection equation, generating a view image corresponding to the rear side of the car according to the corrected fisheye image of at least one camera corresponding to the rear side of the car and a second image projection equation, generating a view image corresponding to the left side of the car according to the corrected fisheye image of at least one camera corresponding to the left side of the car and a third image projection equation, generating a view image corresponding to the right side of the car according to the corrected fisheye image of at least one camera corresponding to the right side of the car and a fourth image projection equation, and stitching the view image corresponding to the front side of the car, the view image corresponding to the rear side of the car, the view image corresponding to the left side of the car, and the view image corresponding to the right side of the car to generate the view image around the car and outputting the view image around the car to a car monitor.

14. The calibration circuit of claim 13, wherein the bus is an I²C communication bus.

15. The calibration circuit of claim 13, wherein the bus is a serial peripheral interface bus (SPI).

16. The calibration circuit of claim 13, further comprising:
a memory management unit for managing the fisheye images captured by the at least four cameras, and storing the corrected fisheye images corresponding to the at least four cameras to an external memory.

17. The calibration circuit of claim 13, further comprising:
a register for storing the view angles, the image centers, and the lens curvature parameters of the at least four cameras.
